(19) United States
(12) Patent Application Publication
(10) Pub. No.: US 2021/0406682 A1
(43) Pub. Date: Dec. 30, 2021

(54) QUANTIZATION OF NEURAL NETWORK MODELS USING DATA AUGMENTATION

(71) Applicant: ADVANCED MICRO DEVICES, INC., Santa Clara, CA (US)

(72) Inventors: Rajy MEEYAKHAN RAWTHER, Santa Clara, CA (US); Michael L. SCHMIT, Santa Clara, CA (US)

(21) Appl. No.: 17/030,021

(22) Filed: Sep. 23, 2020

Related U.S. Application Data
(60) Provisional application No. 63/044,545, filed on Jun. 26, 2020.

(51) Int. Cl. G06N 3/08; G06F 17/18

(52) U.S. Cl. CPC G06N 3/08; G06F 17/18

(57) ABSTRACT

A neural network is trained at a first precision using a training dataset. The neural network is then calibrated using an augmented calibration dataset that includes a first dataset and one or more second datasets produced by modifying the first dataset. A range of values of activations of nodes in the neural network at the first precision is determined based on inputs to the neural network from the augmented calibration dataset. The activations of the nodes are then quantized to a second precision based on the range of values of the activations of the nodes at the first precision. The first precision is higher than the second precision. For example, in some cases the first precision is a 32-bit floating point precision and the second precision is an 8-bit integer precision.

### CROSS-REFERENCE TO RELATED APPLICATIONS

The present application claims priority to Provisional Patent Application Ser. No. 63/044,585, entitled “Quantization of Neural Network Models Using Data Augmentation” and filed on Jun. 26, 2020, the entirety of which is incorporated by reference herein.

### BACKGROUND

Artificial neural networks (referred to herein as “neural networks”) are computing systems that learn tasks such as computer vision, speech recognition, character recognition, machine translation, medical diagnostics, gameplay, and the like. A neural network includes a set of nodes that are interconnected by edges that convey signals between the nodes. Weights are associated with the edges and are used to modify the strength (or values) of the signals that are transmitted between nodes along the corresponding edges. The nodes implement a nonlinear activation function that determines a value of a signal output from the node based upon one or more inputs to the node and, in some cases, a threshold value of the activation function. The value of the output signal is typically referred to as the “activation” of the node.

In some cases, subsets of the nodes are grouped into layers. A layer that receives external data is referred to as the input layer and a layer that produces a result is referred to as the output layer. The input layer and the output layer can be separated by one or more hidden layers. Other than the input layer and output layer, nodes in one layer connect only to the nodes in the immediately preceding layer and immediately following layer. The layers are fully connected if every node in one layer connects to every node in the next layer. Alternatively, a group (or pool) of nodes in a first layer can connect to a single node in a second layer, which may therefore have a smaller number of nodes than the first layer.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that quantizes parameters of a neural network based on an augmented calibration dataset according to some embodiments.

FIG. 2 is a block diagram of a group of calibration datasets used for quantization of neural networks according to some embodiments.

FIG. 3 is a block diagram of a neural network that is calibrated using an augmented calibration dataset according to some embodiments.

FIG. 4 is a mapping of values of activation functions of nodes in a neural network to quantize values of the activation functions according to some embodiments.

FIG. 5 is a flow diagram of a method of quantizing parameters of a trained neural network model based on an augmented calibration dataset according to some embodiments.

FIG. 6 is a flow diagram of a method of quantizing and de-quantizing parameters of a trained neural network model according to some embodiments.

### DETAILED DESCRIPTION

Neural networks are trained on training datasets to “learn” a model of the dataset, e.g., by modifying the weights of the edges (and in some cases, the thresholds of the activation function or other parameters), so that the neural network can perform a predetermined task on other datasets. For example, a neural network can be trained on a dataset including typed or handwritten letters and numerals to learn a model that enables the neural network to identify characters in images of documents. The model implemented by the neural network is therefore represented by the weights and, in some cases, the activation function thresholds that are determined during the training process. The weights, thresholds, and activations of the nodes are typically determined to high precision, e.g., using 32-bit floating point values, resulting in neural network models having large memory footprints and long execution latencies. Quantization of the neural network model from the higher-precision values to a lower precision, e.g., to 8-bit integer values, reduces the memory footprint and decreases the execution latency of the model.

Quantization of activations of the nodes is performed using a scale factor that scales the activation values to the quantized values. The scale factor should correspond to the range of activation values of the nodes in the neural network, or in subsets of the nodes such as separate layers of the neural network. For example, if the range of activation values of the nodes in a layer of the neural network is (−r, +r), and the quantization is to 8-bit integers, the scale factor should be s=127/r. However, the range of values of the activations vary at runtime because activations of the nodes depend on the input to the neural network model. The range is typically estimated by running the model using inputs drawn from a calibration dataset that is a minimal subset selected from the training dataset. Activations of the nodes are determined while the model is processing the inputs from the calibration dataset. The range of values of the activations (or threshold) is chosen to minimize an error between real values of the activations and the quantized values. The range (or threshold) is then used to determine the scale factor. However, the calibration dataset does not necessarily reflect the actual data that will be processed by the model. For example, the calibration dataset can include random values. Quantizing the activations based on the input values from the calibration dataset can therefore decrease accuracy of the quantized model compared to the original floating-point model.

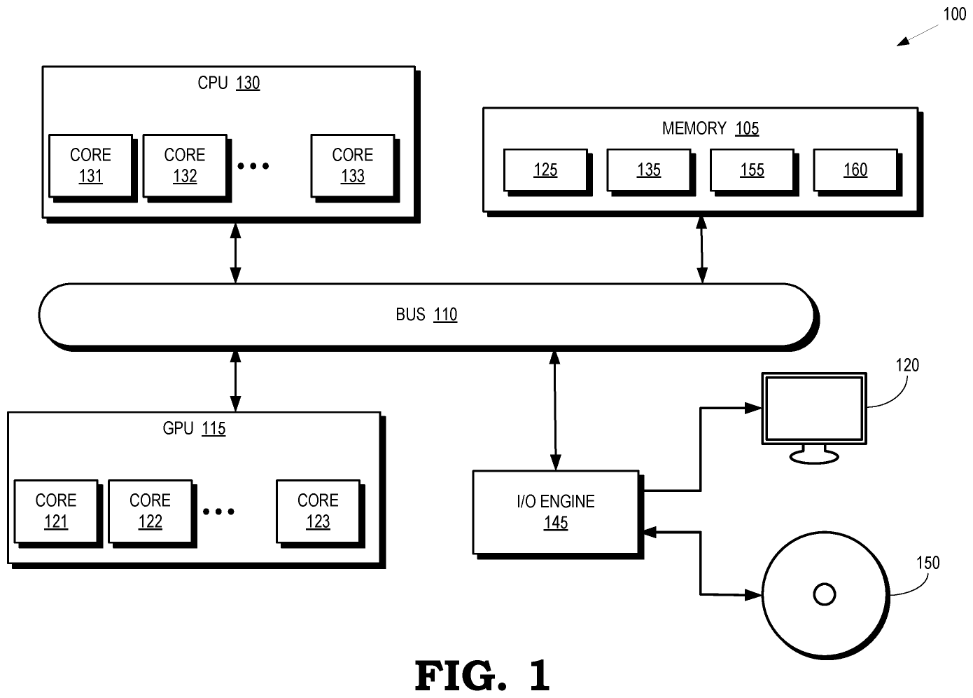

FIGS. 1-6 disclose techniques for improving the accuracy of a quantized neural network model by generating a calibration dataset and augmenting the calibration dataset to generate an augmented calibration dataset. Some embodiments of the augmented calibration dataset include the calibration dataset and one or more additional datasets produced by modifying the calibration dataset. Examples of operations that are used to modify the calibration dataset include, but are not limited to, sharpening, contrast changes, hue/saturation changes, cropping/padding, perspective transformations, affine transformations, as well as rotations, inversions, and mirroring of input images. In some embodiments, the operations used to modify the calibration dataset are chosen based on one or more characteristics of the neural network model or the feature set of one or more of the layers of the neural network.

Weights of edges between the nodes in the neural network model and, in some embodiments, thresholds used by activation functions in the nodes are determined by training the neural network model on a training dataset. In some embodiments, the calibration dataset is a subset of the training dataset. The neural network model is trained at a first precision, such as a 32-bit floating point precision, and so the weights of the edges (and, in some embodiments, the thresholds) are represented as numbers at the first precision. After training the neural network model, a range of values of activations of nodes in the neural network is determined at the first precision based on inputs from the augmented calibration dataset. A scale factor is determined based on the range and a second precision (such as an 8-bit integer precision) that is lower than the first precision. The scale factor is then used to quantize the activations of the nodes to the second precision during processing of other inputs to the quantized neural network model. The weights and, in some embodiments, the thresholds are also quantized at the second precision for processing the inputs to the quantized neural network model. In some embodiments, different scale factors are determined for nodes in different layers of the neural network based on the ranges of activations for the nodes in the different layers.

FIG. 1 is a block diagram of a processing system 100 that quantizes parameters of a neural network based on an augmented calibration dataset according to some embodiments. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory since it is implemented external to the processing units implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a graphics processing unit (GPU) 115 that renders images for presentation on a display 120. For example, the GPU 115 renders objects to produce values of pixels that are provided to the display 120, which uses the pixel values to display an image that represents the rendered objects. The GPU 115 implements a plurality of processor cores 121, 122, 123 (collectively referred to herein as “the processor cores 121-123”) that execute instructions concurrently or in parallel. The number of processor cores 121-123 implemented in the GPU 115 is a matter of design choice. Some embodiments of the GPU 115 are used for general purpose computing. The GPU 115 executes instructions such as program code 125 stored in the memory 105 and the GPU 115 stores information in the memory 105 such as the results of the executed instructions.

The processing system 100 includes a central processing unit (CPU) 130 that is connected to the bus 110 and therefore communicates with the GPU 115 and the memory 105 via the bus 110. The CPU 130 implements a plurality of processor cores 131, 132, 133 (collectively referred to herein as “the processor cores 131-133”) that execute instructions concurrently or in parallel. The number of processor cores 131-133 implemented in the CPU 130 is a matter of design choice. The processor cores 131-133 execute instructions such as program code 135 stored in the memory 105 and the CPU 130 stores information in the memory 105 such as the results of the executed instructions. The CPU 130 is also able to initiate graphics processing by issuing draw calls to the GPU 115. Some embodiments of the CPU 130 implement multiple processor cores (not shown in FIG. 1 in the interest of clarity) that execute instructions concurrently or in parallel.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the GPU 115, or the CPU 130. In the illustrated embodiment, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the GPU 115 or the CPU 130.

The processing system 100 implements a neural network such as a convolutional neural network (CNN), deep neural network (DNN), recurrent neural network (RNN), and the like. For example, a CNN is a class of neural networks that learn how to perform tasks such as computer vision, driver assistance, image recognition, natural language processing, and game play. A CNN architecture includes a stack of layers that implement functions to transform an input volume (such as a digital image) into an output volume (such as labeled features detected in the digital image). The layers in a CNN are separated into convolutional layers, pooling layers, and fully connected layers. Multiple sets of convolutional, pooling, and fully connected layers are interleaved to form a complete CNN. The functions implemented by the layers in a CNN are explicit (i.e., known or predetermined) or hidden (i.e., unknown). A DNN is a type of CNN that performs deep learning on tasks that contain multiple hidden layers. For example, a DNN that is used to implement computer vision includes explicit functions (such as orientation maps) and multiple hidden functions in the hierarchy of vision flow. An RNN is a type of neural network that forms a directed graph of connections between nodes along a temporal sequence and exhibits temporal dynamic behavior. For example, an RNN uses an internal state to process sequences of inputs. The RNN is typically applied to deep learning problems such as handwriting recognition and speech recognition.

The neural network 155 is represented as program code that is configured using a corresponding set of parameters and stored in the memory 105. The neural network 155 is therefore executed on the GPU 115, the CPU 130, or other processing units including field programmable gate arrays (FPGA), application-specific integrated circuits (ASIC), processing in memory (PIM), and the like. If the neural network 155 implements a known function that is trained using a corresponding known dataset, the neural network 155 is trained (i.e., the values of the parameters that define the neural network are established) by providing input values of the known training dataset to the neural network executing on the GPU 115 or the CPU 130 and then comparing the output values of the neural network to labeled output values in the known training dataset. Error values are determined based on the comparison and back propagated to modify the values of the parameters that define the neural network. This process is iterated until the values of the parameters satisfy a convergence criterion.

Neural networks are typically trained at a high precision, e.g., using 32-bit floating point variables, and values of the parameters of the trained neural network are represented at the high precision. As discussed herein, the parameters of the trained neural network 155 include values of weights of edges between the nodes of the neural network 155, activations of the nodes in response to input received from the edges, thresholds used to determine whether a note is activated, and the like. Quantization of the parameters of the neural network 155 to a lower precision, e.g., to 8-bit integer values, can reduce the memory footprint and decrease the execution latency of the model. However, values of the activations of the nodes are only known at runtime because the values depend on the inputs to the neural network 155. Calibration is therefore used to estimate ranges of the activations of the nodes. Although calibration is discussed in terms of quantization from a 32-bit floating point variable to an 8-bit integer value, quantization is also used for other precisions. For example, the neural network can be trained at precisions including 64-bit floating point or 16-bit floating point and the neural network can be quantized to precisions including 4-bit integers, 3-bit integers, and the like.

The processing system 100 calibrates the quantization process using an augmented calibration dataset 160 that includes a first dataset and one or more second datasets produced by modifying the first dataset. A range of values of activations of nodes in the neural network 155 at the first precision is determined based on inputs to the neural network 155 from the augmented calibration dataset 160. The activations of the nodes are then quantized to a second precision based on the range of values of the activations of the nodes at the first precision. The first precision is higher than the second precision. For example, in some cases the first precision is a 32-bit floating point precision and the second precision is an 8-bit integer precision.

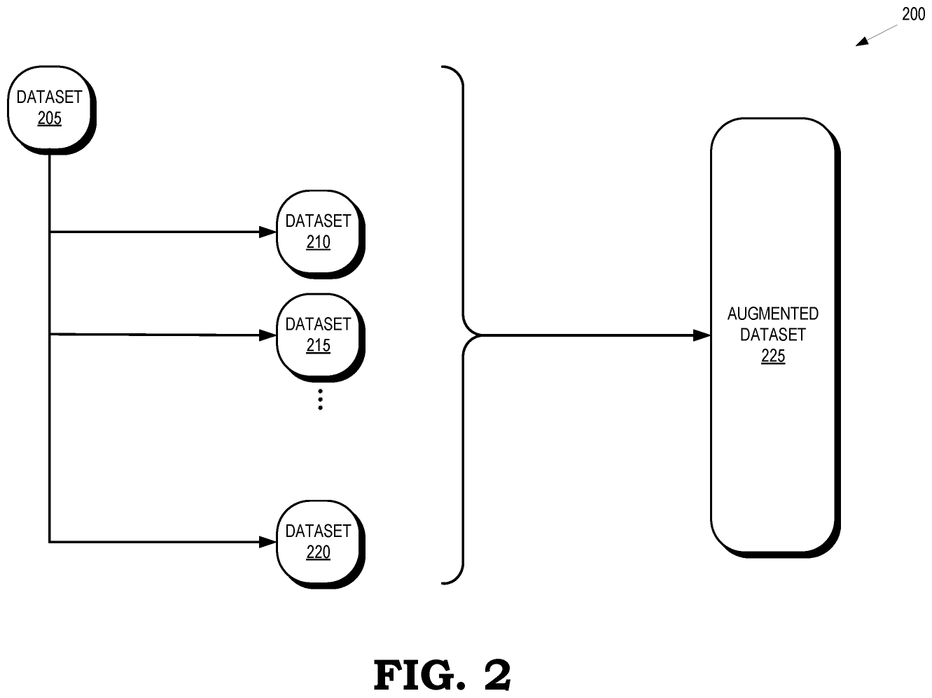

FIG. 2 is a block diagram of a group 200 of calibration datasets used for quantization of neural networks according to some embodiments. One or more of the calibration datasets in the group 200 are used to calibrate neural networks implemented in some embodiments of the processing system 100 shown in FIG. 1. The group 200 includes a first dataset 205 such as a subset of a training dataset that is used to train the neural network. One or more operations are performed on the first dataset 205 to generate additional datasets 210, 215, 220. Although three additional datasets 210, 215, 220 are shown in FIG. 2, some embodiments generate more or fewer additional datasets. In the illustrated embodiment, the additional datasets 210, 215, 220 are combined to generate an augmented calibration dataset 225. The additional datasets 210, 215, 220 can be combined using operations such as concatenation, merging, and the like.

The operations performed on the first dataset 205 modify the first dataset 205. The operations include, but are not limited to, sharpening an image in the first dataset 205, changing contrast between portions of the first dataset 205, changing hue of portions of the first dataset 205, changing saturation of portions of the first dataset 205, cropping portions of the first dataset 205, padding portions of the first dataset 205, transforming perspective used to form the first dataset 205, performing an affine transformation on the first dataset 205, rotating the first dataset 205, inverting the first dataset 205, and mirroring the first dataset 205. For example, the additional dataset 210 can be formed by sharpening an image in the first dataset 205 to reduce blurring between portions of the first dataset. For another example, the additional dataset 215 can be formed by cropping portions of the first dataset 205 to remove one subset of the first dataset 205 and leave behind another subset of the first dataset 205. For yet another example, the additional dataset is 220 can be formed by performing an affine transformation on the first dataset 205.

In some embodiments, the operations that are performed on the first dataset 205 to generate one or more additional datasets 210, 215, 220 are chosen based on one or more characteristics of the neural network model or a feature set of one or more layers of the neural network. For example, rotation, inversion, or mirroring operations are performed to provide different perspectives if the first dataset 205 includes information that represents an image of the scene or spatial relationships between objects, which can improve the neural network's ability to identify objects. For another example, if the first dataset 205 includes information that represents handwriting and the neural network is trained to perform character recognition, the operations can include sharpening the image, enhancing contrast, and cropping the first dataset 205 to remove whitespace and thereby improve the neural network's ability to recognize characters.

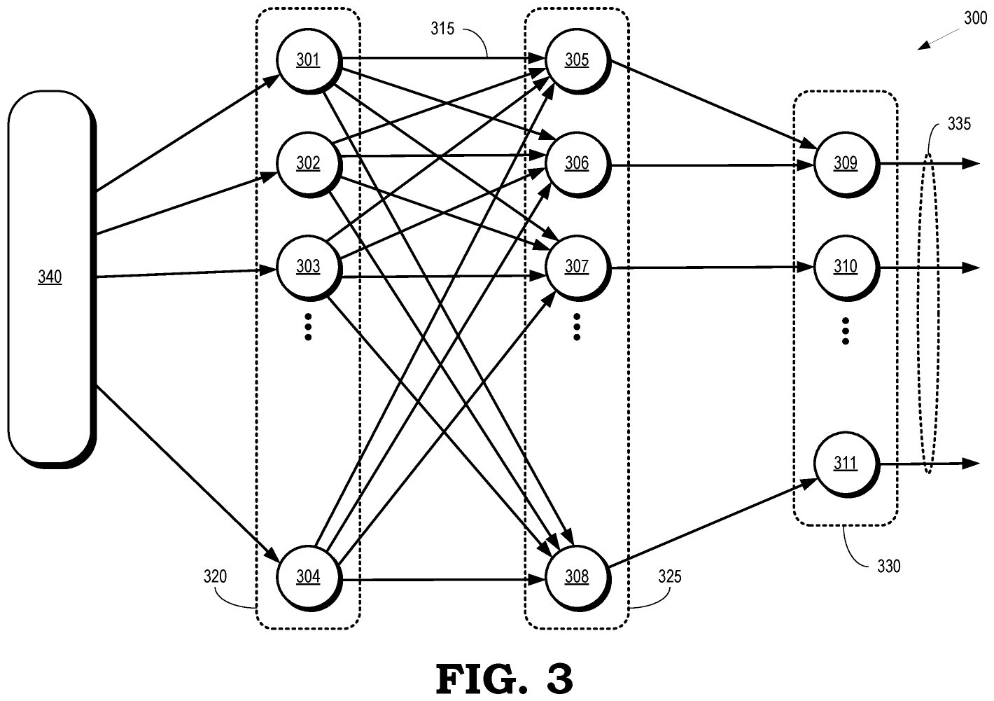

FIG. 3 is a block diagram of a neural network 300 that is calibrated using an augmented calibration dataset according to some embodiments. The neural network 300 is implemented in some embodiments of the processing system 100 shown in FIG. 1. The neural network 300 includes nodes 301, 302, 303, 304, 305, 306, 307, 308, 309, 310, 311, which are collectively referred to herein as “the nodes 301-311.” The nodes 301-311 are interconnected by edges 315, only one indicated by a reference numeral in the interest of clarity. In the illustrated embodiment, the nodes 301-311 are partitioned into layers 320, 325, 330. Nodes in one layer only connect to the nodes in the subsequent layer. For example, the nodes 301-304 in the layer 320 are connected to nodes 305-308 in the layer 325 by corresponding edges 315.

The nodes 301-311 generate values based on the inputs received on the edges 315, weights associated with the edges 315, and (in some embodiments) a bias value associated with the nodes 301-311. For example, the node 305 can calculate a value, Y, by summing over the inputs from the edges 315 that connect the node 305 to the nodes 301-304:

Y=Σ(weight*input)+bias

The nodes 301-311 implement an activation function to determine whether to generate an output signal based on the value, Y, calculated at the nodes 301-311. Some embodiments of the activation function use a threshold to determine whether to generate an output signal. For example, the activation function can be implemented as a step function:

$$A = \{ \begin{matrix}1 ; Y \geq threshold \\ 0 ; Y < threshold\end{matrix}$$

The activation function can also be implemented as a linear function, a sigmoid function, a tanh function, a rectified linear unit (ReLu), a parametric rectified linear unit (PreLU), and the like.

The neural network 300 is trained at a first precision using a training dataset. Training the neural network 300 includes determining values of the weights of the edges 315, as well as other parameters including parameters that define the activation functions implemented in the nodes 301-311 such as the thresholds used to determine whether to generate an output signal. Once trained, the neural network 300 generates (or infers) output signals 335 in response to an input 340. In some embodiments, the input 340 includes an augmented calibration dataset that is used to calibrate the neural network 300, e.g., by determining ranges of values of the parameters of the trained neural network 300. The input 340 used to calibrate the neural network 300 includes some embodiments of the augmented calibration dataset 225 shown in FIG. 2. Calibration of the neural network 300 includes determining a scale factor that is used to quantize the parameters of the neural network 300 to a second precision that is lower than the first precision.

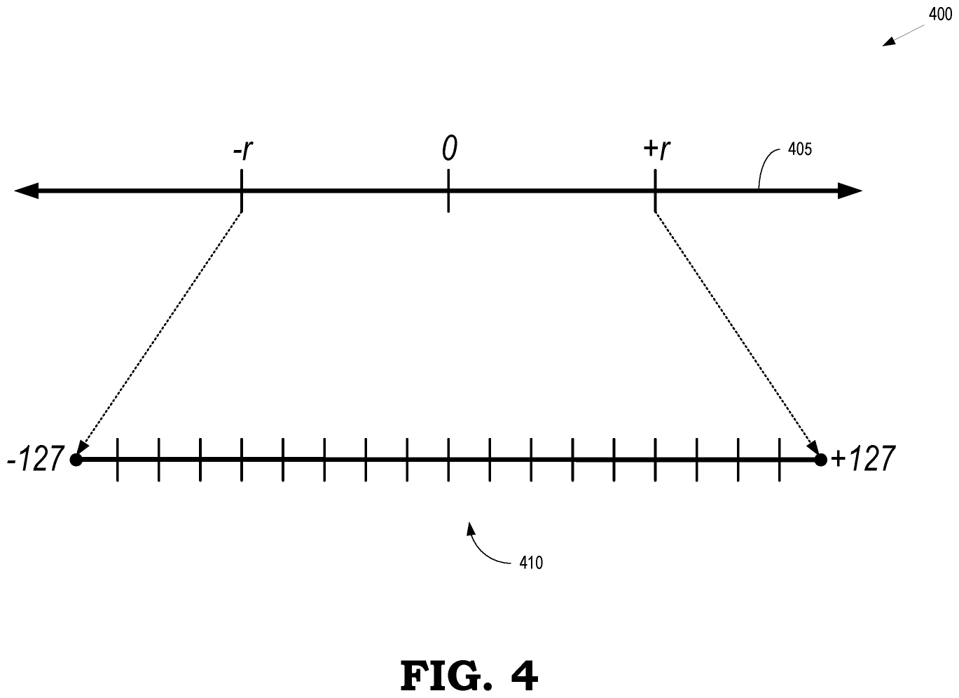

FIG. 4 is a mapping 400 of values of activation functions of nodes in a neural network to quantized values of the activation functions according to some embodiments. The mapping 400 is applied to values of activation functions determined for some embodiments of the neural network 300 shown in FIG. 3. Values of the activation functions of the nodes in the neural network are plotted along the axis 405 and the mapping 400 is used to map (or quantize) the values at a lower precision as indicated along the axis 410. In the illustrated embodiment, the range of values of the activation functions extends over the range (−r, +r) and the values are measured in a first precision such as the 32-bit floating point precision. The range is determined using an augmented calibration dataset such as the augmented calibration dataset 225 shown in FIG. 2.

In the illustrated embodiment, quantization is performed to map values of the activation functions in the range (−r, +r) to 8-bit integers that range from −127 to +127. If x represents a value of an activation of the node, the quantization operation is represented as:

Quantize(x,r)=round(s*clip(x,−r,+r))

The scale factor, s, is determined based on the measured range (−r, +r) of values of the activation functions of the nodes using the relation:

$$s = \frac{127}{r}$$

Quantization of the activation functions, as well as other parameters of the neural network, is performed without retraining the neural network in some embodiments. The augmented calibration dataset is used to determine the minimum and maximum range of the floating-point values to quantize, e.g., the value r in the illustrated embodiment. This process is referred to as thresholding because the process chooses a threshold that minimizes an error between the original precision values and the quantized values For example, the thresholding algorithm chooses a candidate threshold and performs forward passes through the neural network at the original (higher) precision and the lower precision. An error (e.g., a difference between the results for the higher and lower precision passes) is computed after the forward pass and the error is fed back to modify the threshold value. This process is repeated for various threshold values using the calibration dataset to determine a threshold that minimizes the error or reduces the error below a predetermined error value. In some embodiments, quantization is fine-tuned by retraining the neural network with coarsely quantized weights to increase the accuracy of the neural network.

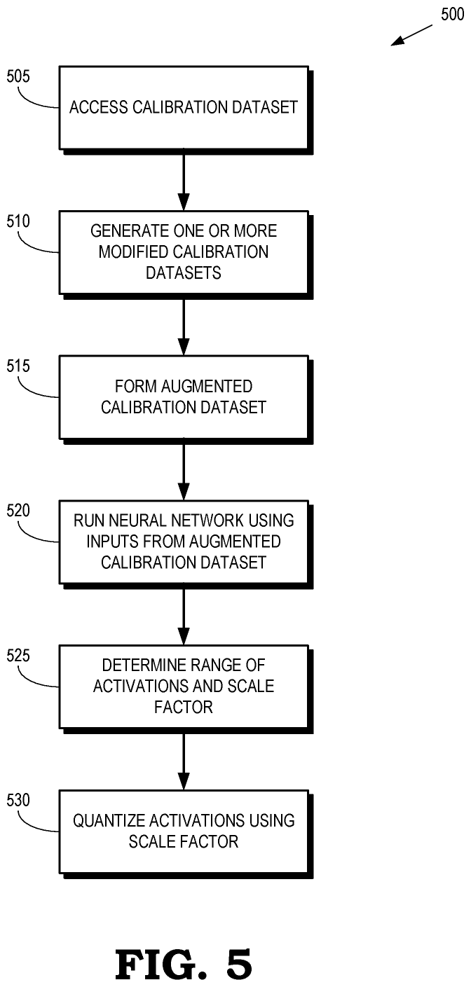

FIG. 5 is a flow diagram of a method 500 of quantizing parameters of a trained neural network model based on an augmented calibration dataset according to some embodiments. The method 500 is implemented in some embodiments of the processing system 100 shown in FIG. 1 and the neural network 300 shown in FIG. 3.

At block 505, a processing unit accesses a calibration dataset. Some embodiments of the calibration dataset are a subset of a training dataset that is used to train the neural network to determine the parameters of the trained neural network model to a first precision. At block 510, the processing unit generates one or more modified calibration datasets by performing one or more operations on the calibration dataset. At block 515, the processing unit forms an augmented calibration dataset, e.g., by combining the calibration dataset and the one or more modified calibration datasets.

At block 520, a processing unit (which can be the same or different than the processing unit used to perform the actions in blocks 505, 510, 515) runs the neural network using inputs from the augmented calibration dataset. At block 525, the processing unit determines a range of activations of the nodes in the trained neural network concurrently with running the neural network using the inputs from the augmented calibration dataset. The processing unit then determines a scale factor for the quantization procedure based on the measured range of activations.

At block 530, a processing unit (which can be the same or different than the processing unit used to perform the actions in blocks 505, 510, 515, 520) quantizes activations of the nodes using the scale factor. For example, the activations of the nodes can be quantized concurrently with the neural network executing on the processing unit to perform inference on another dataset that is provided to the neural network.

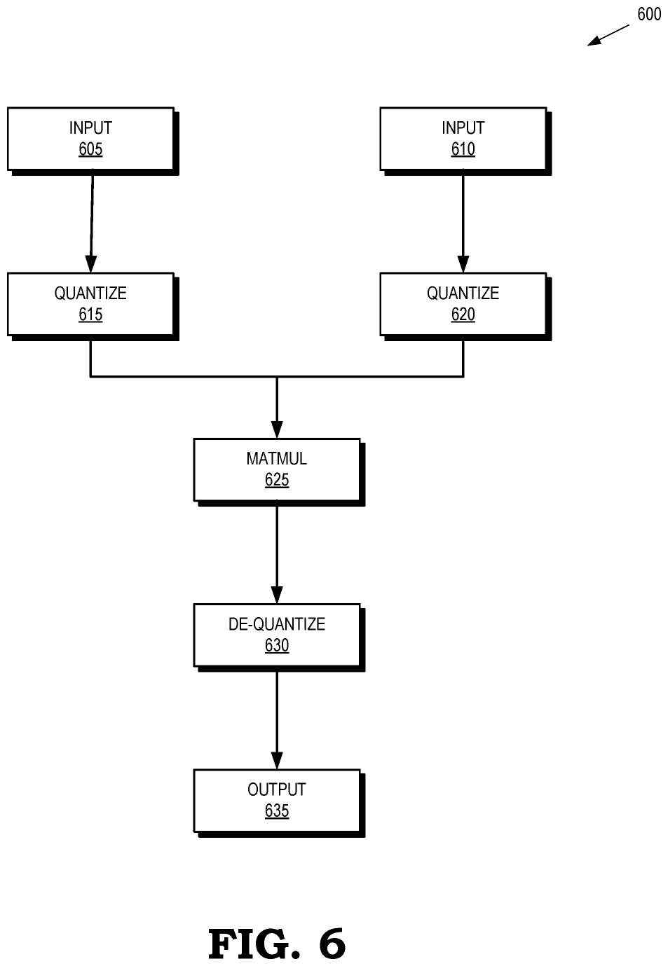

FIG. 6 is a flow diagram of a method 600 of quantizing and de-quantizing parameters of a trained neural network model according to some embodiments. The method 600 is implemented in some embodiments of the processing system 100 shown in FIG. 1 and the neural network 300 shown in FIG. 3.

At blocks 605, 610, a processing unit receives corresponding input values that have a first precision such as a 32-bit floating point precision. At blocks 615, 620, the inputs are quantized based on corresponding scale factors associated with the inputs received at the block 605, 610. The scale factors are determined based on a valid minimum and maximum range of the input values received at blocks 605, 610, as discussed herein.

In the illustrated embodiment, the trained neural network performs a matmul operation at block 625. The matmul operation is a tensor operation that performs elementwise multiplication of two input sensors to produce an output tensor. However, the trained neural network performs other operations in some embodiments. At block 630, the processing unit de-quantizes the output tensor produced by the matmul operation. In some embodiments, the elements of the output tensor are de-quantized based on the quantization scale factors. For example, the elements of the output tensor are de-quantized by dividing the values by a product of the quantization scale factors applied to the respective inputs at block 615, 620. At block 635, the de-quantized output is provided at the first precision.

Some embodiments of the techniques disclosed herein are implemented on a computer readable storage medium that includes a non-transitory storage medium, or combination of non-transitory storage media, accessible by a computer system during use to provide instructions and/or data to the computer system. Such storage media include, but are not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software includes the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device is not necessarily required, and that one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
accessing an augmented calibration dataset for a neural network that has been trained at a first precision, the augmented calibration dataset comprising a first dataset and at least one second dataset produced by modifying the first dataset;
determining a range of values of activations of nodes in the neural network at the first precision based on inputs to the neural network from the augmented calibration dataset; and
quantizing the activations of the nodes to a second precision based on the range of values of the activations of the nodes at the first precision.

2. The method of claim 1, wherein the first dataset is a subset of a first training dataset that is used to train the neural network at the first precision.

3. The method of claim 2, further comprising:
generating the at least one second dataset by performing operations on the first dataset comprising at least one of sharpening, changing contrast, changing hue, changing saturation, cropping, padding, transforming perspective, performing an affine transformation, rotating, inverting, and mirroring.

4. The method of claim 3, wherein performing the operations on the first dataset comprises selecting operations used to modify the first dataset based on one or more characteristics of the neural network model or a feature set of at least one layer of the neural network.

5. The method of claim 1, wherein quantizing the activations of the nodes to the second precision comprises determining a scale factor based on the range and the second precision.

6. The method of claim 5, wherein determining the scale factor comprises determining a plurality of scale factors for nodes in a plurality of layers of the neural network based on ranges of activations for the nodes in the plurality of layers.

7. The method of claim 5, wherein quantizing the activations of the nodes to the second precision comprises scaling the activations of the nodes by the scale factor.

8. The method of claim 1, further comprising:
quantizing at least one of weights applied to edges between the nodes in the neural network and activation thresholds of activation functions at the nodes in the neural network from the first precision to the second precision.

9. The method of claim 1, wherein the first precision is a 32-bit floating point precision and the second precision is an 8-bit integer precision.

10. An apparatus comprising:
an augmented calibration dataset for a neural network that is trained at a first precision, the augmented calibration dataset comprising a first dataset and at least one second dataset produced by modifying the first dataset; and
a processing unit configured to determine a range of values of activations of nodes in the neural network at the first precision based on inputs to the neural network from the augmented calibration dataset and quantize the activations of the nodes to a second precision based on the range of values of the activations of the nodes at the first precision.

11. The apparatus of claim 10, wherein the first dataset is a subset of a first training dataset that is used to train the neural network at the first precision.

12. The apparatus of claim 11, wherein the processing unit is configured to generate the at least one second dataset by performing operations on the first dataset comprising at least one of sharpening, changing contrast, changing hue, changing saturation, cropping, padding, transforming perspective, performing an affine transformation, rotating, inverting, and mirroring.

13. The apparatus of claim 12, wherein the processing unit is configured to select operations used to modify the first dataset based on one or more characteristics of the neural network model or a feature set of at least one layer of the neural network.

14. The apparatus of claim 10, wherein the processing unit is configured to determine a scale factor based on the range and the second precision.

15. The apparatus of claim 14, wherein the processing unit is configured to determine a plurality of scale factors for nodes in a plurality of layers of the neural network based on ranges of activations for the nodes in the plurality of layers.

16. The apparatus of claim 14, wherein the processing unit is configured to scale the activations of the nodes by the scale factor.

17. The apparatus of claim 10, wherein the processing unit is configured to quantize at least one of weights applied to edges between the nodes in the neural network and activation thresholds of activation functions at the nodes in the neural network from the first precision to the second precision.

18. The apparatus of claim 10, wherein the first precision is a 32-bit floating point precision and the second precision is an 8-bit integer precision.

19. A method comprising:
performing inference on a first input dataset to a neural network that is trained at a first precision using a training dataset, wherein the first input dataset is generated by modifying a subset of the training dataset;
measuring activations of nodes of the neural network concurrently with performing inference on the input dataset;
quantizing the activations of the nodes to a second precision that is lower than the first precision based on the measured activations of the nodes; and
performing inference on a second input dataset to the neural network using the activations that are quantized to the second precision.

20. The method of claim 19, wherein quantizing the activations of the nodes to the second precision comprises determining a scale factor based on the second precision and the measured activations of the nodes and scaling the activations of the nodes by the scale factor.
